(19) United States
(12) Patent Application Publication
(10) Pub. No.: US 2014/0067413 A1
(43) Pub. Date: Mar. 6, 2014

(54) OPERATING ROOM MANAGEMENT SYSTEM AND RELATED METHODS

(71) Applicant: David S. GHIVIZZANI, Clermont, FL (US)

(72) Inventor: David S. GHIVIZZANI, Clermont, FL (US)

(21) Appl. No.: 14/013,501

(22) Filed: Aug. 29, 2013

Related U.S. Application Data
(60) Provisional application No. 61/694,609, filed on Aug. 29, 2012.

(51) Int. Cl. G06F 19/00

(52) U.S. Cl. CPC G06F 19/327
USPC 705/2

(57) ABSTRACT

An operating room management system is for monitoring operating rooms. The operating room management system may include a server, and access devices, each access device being associated with a respective operating room. Each access device may communicate with the server, receive input regarding a current status for a procedure associated with the respective operating room, and display a local status interface including a performance characteristic for the procedure associated with the respective operating room. The operating room management system may include a display communicating with the server and displaying a global status interface including the current status and the performance characteristic of the operating rooms.

### RELATED APPLICATIONS

This application is based upon prior filed copending application Ser. No. 61/694,609 filed Aug. 29, 2012, the entire subject matter of which is incorporated herein by reference in its entirety.

### FIELD OF THE INVENTION

The present invention relates to the field of medical management systems, and, more particularly, to a hospital management system and related methods.

### BACKGROUND OF THE INVENTION

Health care facilities, such as hospitals, are under increasing financial pressure due to the global economic downturn. The determination of the federal and state payers to reduce health care payments, and the trend of private insurers to move their insured to high deductible plans. Also, government payment strategies now include reductions in payments for failures to achieve certain outcome and quality targets, a move that private insurers are sure to follow. Accordingly, there is a desire for hospitals to more efficiently manage hospital operations and resources so as to cut costs while maintaining or improving quality.

In particular, the surgical suites (i.e. operating room or “OR”) of a hospital are an area of concern because such suites are high cost/revenue divisions. Multiple providers in separate geographic areas are engaged in the preparation and care of each surgical patient, and these providers must work both sequentially and in parallel within a tight schedule to ensure a cost-efficient perioperative process. If any single perioperative activity is delayed, that delay can affect not only the overall timing of that case, but can have a ripple effect that upsets the entire OR schedule. Although the scheduling of cases is typically performed within electronic clinical information systems, the actual management of the perioperative work-flow is most often coordinated with the use of a dry erase whiteboards in a main corridor. When a change needs to be made, personnel must manually erase and write in changes and then either call or personally visit every other key location to coordinate the updated schedule. This process is labor intensive, inefficient, and subject to a variety of communication errors.

### SUMMARY OF THE INVENTION

In view of the foregoing background, it is therefore an object of the present invention to provide an operating room management system that is efficient and robust.

This and other objects, features, and advantages in accordance with the present invention are provided by an operating room management system for monitoring a plurality of operating rooms. The operating room management system may comprise a server, and a plurality of access devices, each access device being associated with a respective operating room from the plurality thereof and for communicating with the server, receiving input regarding a current status for a procedure associated with the respective operating room, and displaying a local status interface including at least one performance characteristic for the procedure associated with the respective operating room. The operating room management system may also include a display communicating with the server and displaying a global status interface comprising the current status and the at least one performance characteristic of the plurality of the operating rooms. Advantageously, personnel are efficiently informed of assignments and current changes in scheduling in real time.

More specifically, the local status interface may include a plurality of buttons associated with respective activities for the procedure associated with the respective operating room. The at least one performance characteristic may comprise a colorized indicator for timely performance for the procedure associated with the respective operating room. The global status interface may include a progress bar indicating a current progress of the procedure associated with the respective operating room.

For example, the global status interface may include a plurality of characteristics associated with the plurality of operating rooms including a scheduled procedure start time, a procedure description, assigned personnel, and associated notes. The server may selectively change the at least one performance characteristic based upon historical data, and assigned personnel for the procedure associated with the respective operating room.

In some embodiments, the operating room management system may further comprise at least one mobile access terminal communicating with the server and associated with a respective user assigned to a given procedure for a given operating room. The server may send a text message to the at least one mobile access terminal based upon a current progress of the given procedure. Each access terminal may include a touch screen interface.

Another aspect is directed to a method of using an operating room management system for monitoring a plurality of operating rooms, the operating room management system comprising a server, a plurality of access devices, each access device being associated with a respective operating room from the plurality thereof, and a display. The method may include using each access terminal for communicating with the server, receiving input regarding a current status for a procedure associated with the respective operating room, and displaying a local status interface including at least one performance characteristic for the procedure associated with the respective operating room. The method may also include using the display for communicating with the server and displaying a global status interface comprising the current status and the at least one performance characteristic of the plurality of the operating rooms.

### BRIEF DESCRIPTION OF THE DRAWINGS

FIG. 1 is a schematic diagram of a management system, according to the present invention.

FIG. 2 is a screenshot from an access terminal in the management system of FIG. 1.

FIGS. 3-6 are screenshots from another access terminal in the management system of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Generally speaking, an operating room work-flow management system is for monitoring and communicating with a plurality of operating rooms. The operating room management system may comprise a server system, a plurality of input devices, a plurality of display devices, and a plurality of website interfaces. Each input device is associated with a respective patient care area where one or more key activities are performed, and communicates bi-directionally with the server, transmitting the current status of one or more activities associated with a surgical case, and displaying a local status interface associated with the respective surgical case. The operating room management system may also include a display communicating with the server and displaying a global status interface comprising the current status and performance characteristics of the plurality of the operating rooms. Advantageously, personnel are efficiently and automatically informed of assignments and current changes in scheduling in real-time via large screen displays and individual mobile communication devices.

For example, the global status interface may include a plurality of characteristics associated with the plurality of operating rooms including a scheduled procedure start time, a procedure description, assigned personnel, associated notes, and real-time color-indicated progress of perioperative activities. The server may selectively change the at least one performance characteristic based upon historical data, and assigned personnel for the procedure associated with the respective operating room.

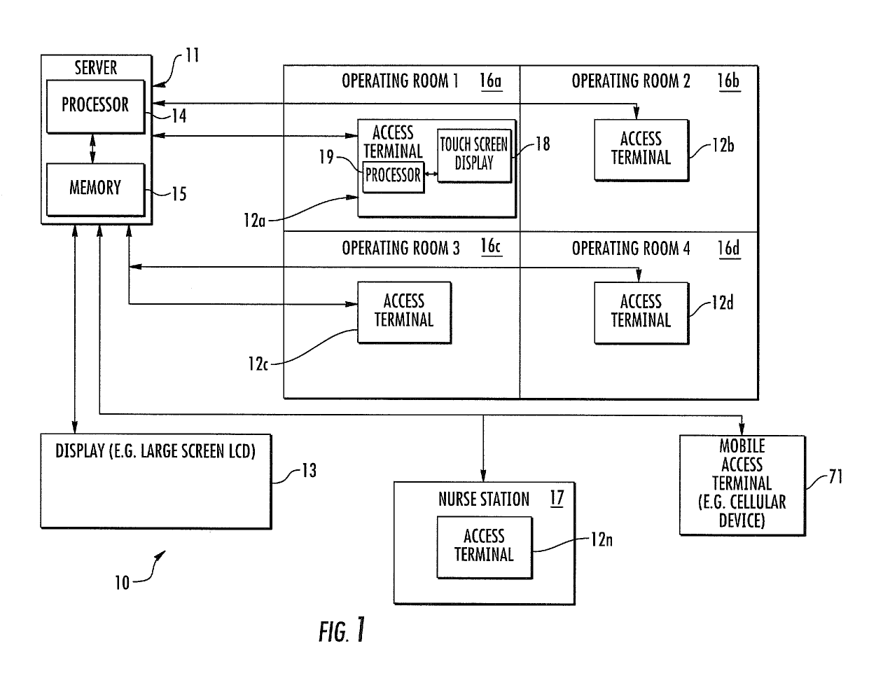

Referring now to FIG. 1, a management system 10 according to the present invention is now described. The management system 10 illustratively includes a server 11, and a plurality of access terminals 12a-12n communicating with the server. The access terminals 12a-12n are illustratively located in each OR 16a-16b (surgical suite, surgical theater, etc.) and other convenient points, such as the illustrated nurse station 17, etc. Each access terminal 12a-12n may comprise a personal computing device, a tablet computing device, or a cellular telephone device, for example (each including a display, not shown). In some embodiments, the access terminals 12a-12d in the ORs each comprises a tablet computing devices permanently mounted on a wall (also permanently coupled to grid power). This installation provides quick and convenient access to personnel in the OR 16a-16d. For example, the illustrated access terminal 12a illustratively includes a processor 19, and a touchscreen display 18 cooperating with the processor for providing the functionality noted herein.

The server 11 may be located onsite at the hospital or may be located remotely (cloud computing embodiments) and coupled to the access terminals 12a-12n via the Internet. In embodiments where the server 11 is remote and accessed over the Internet, the communications with the server 11 are encrypted to maintain security and compliance with Health Insurance Portability and Accountability Act (HIPAA). The server 11 illustratively comprises a processor 14, and a memory 15 cooperating therewith. The server 11 may be a single computing device, a cluster computing device, or a cloud computing device.

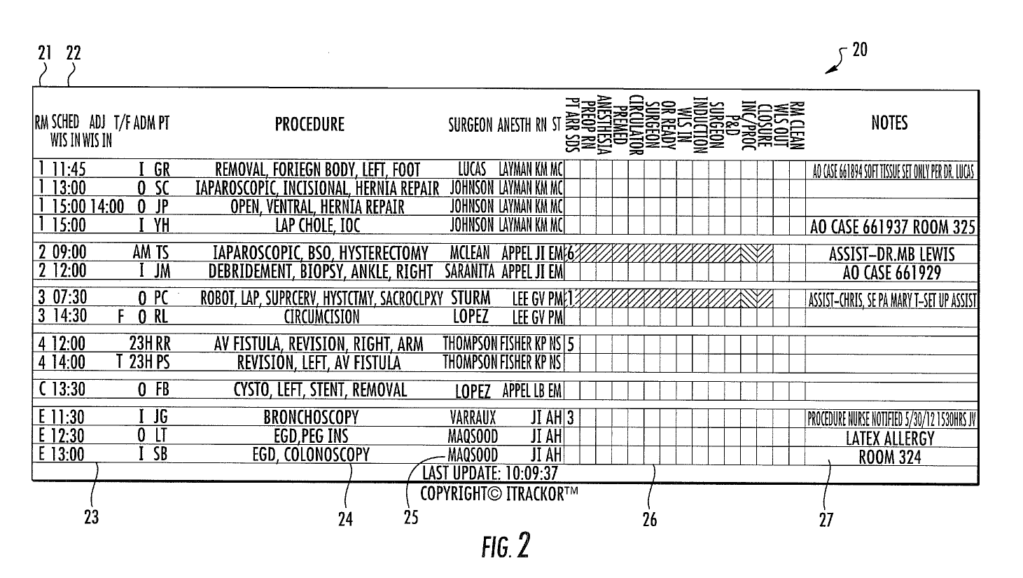

The management system 10 also illustratively includes a display 13 for displaying a current status of the ORs 16a-16d. Referring now to FIG. 2, a screenshot 20 from the display 13 shows the current statuses of the ORs 16a-16d that would be displayed thereon. The display 13 is also communicating with the server 11, via the Internet in some embodiments, to synchronize updates from the management system 10. For example, the display 13 may comprise a large size monitor, such as 42-70 inches in diagonal size, and is located in a main operation area, such as a primary corridor accessing the ORs 16a-16d. The display 13 may provide the current status of the management system 10 including a current status of all ORs 16a-16d, the assigned procedures and teams for each OR, and the location of preparation teams.

In advantageous embodiments, the server 11 updates the current status on the display 13 automatically in real time. The display 13 operates to replace the typical scheduling whiteboard found in the prior art. The size of the display 13 and the prominent placement enables most personnel of the hospital to quickly and readily determine the current status of the ORs 16a-16d.

While the access terminals 12a-12d in the ORs 16a-16d are intended to provide quick and easy data entry for status at the respective OR, the access terminal 12n at the nurse station 17 is intended for more robust data management and may comprise a personal computer device comprising a display, and a keyboard. This access terminal 12n may be stationary, or in other embodiments, may be mobile, for example, comprising a laptop and a wheeled cart. This access terminal 12n includes a more robust input device (e.g. physical keyboard) so appropriate hospital personnel can easily update the OR schedule. The access terminals 12a-12n access the server 11 and the databases stored therein via a web based interface.

On the other hand, the access terminals 12a-12d in the ORs 16a-16d may have more limited touch based interfaces. These terminals 12a-12d provide surgical teams a method of easily and readily updating the status of the respective OR 16a-16d.

In the illustrated embodiment, the management system 10 illustratively includes additional access terminals 71 comprising cellular devices to be kept on person for critical personnel. These cellular devices can receive alert messages from the server 11, thereby alerting the personnel that their assignment has changed, for example.

The management system 10 provides communication and tracking for use in healthcare facility Ors 16a-16d. The management system 10 tracks and displays OR schedule data on one or more displays (one illustrated) 13, as well as desktop computers 12n, and mobile devices (cellular access terminals). The OR schedule data may include a full OR schedule, i.e. case descriptions 24, personnel 25, rooms 21, times 22, and notes 27, location of all peroperative patients 26, progress of the individual activities involved in preparing each individual patient for surgery and in performing the surgical procedure. In addition, the server 11 may provide analysis and reports, including performance analysis, management recommendations, and communicates real time updates to all displays regarding progress of case and case activities, text messages as a response to any activity change automatically sent to selected providers involved with any case, either as a global preference or case-specific. In some embodiments, the management system 10 may also motivate personnel by providing color based feedback on the timeliness of the performance of perioperative activities (i.e. what should be happening, what is happening, what has happened). The management system 10 also adapts, and learns the behavior of the surgical personnel and changes its feedback to the personnel based on individual and group performances. For example, the server 11 may adjust performance parameters for certain personnel, such as demanding faster performance over time.

The current status may include the following information:
1. Relevant details of scheduled surgical cases on the day of surgery
   a. Case description
      i. Scheduled and actual time of surgeries
      ii. Personnel involved in each case
      iii. Type of patient admission (outpatient, inpatient, 23 hour stay, same day admit)
      iv. Miscellaneous notes for each case
   b. Specific OR where the surgeries will be, or are being, performed
   c. Specific perioperative holding bay where the patients are, or were, held prior to surgery
   d. Current location of the patients
   e. Notes relevant to each case

The current status monitors and displays, in real time, the intended start and completion times of the key activities involved in the perioperative care of surgical patients, the actual starting and completion of the activities involved in the perioperative care of surgical patients, and analyzes and reports on the time-based performance of perioperative activities. The current status uses colors to enhance readability. In the left half of the screen, the case list alternates between light and dark blue between each case, and this pattern is maintained whether cases are added, deleted, or changed in order. This alternating pattern also exists between OR rooms 16a-16d in spite of a consistent white spacer line between each room, and the pattern in maintained whether cases are added, deleted, changed in order, or moved to other rooms.

In the right half of the screen, the activity data is displayed (the area with the vertical headings). Colors are used to signify activity status in the following manner:

1. Yellow—when the predetermined time target is reached for a specific activity to begin, the block created by the intersection of the horizontal case line with the vertical activity line turns yellow.
2. Red—when the predetermined time target has passed for a specific activity to have been completed but the activity was never begun, the block created by the intersection of the horizontal case line with the vertical activity line turns red.
3. Blue—when an activity of a case is in progress (and is not yet completed), the activity block turns blue.
4. Green—when an activity of a case is completed, the activity block turns green.

During typical surgical suite operations, several teams of technicians access the OR during a work day. As each team enters the OR, the team uses the access terminal 12a-12d in the respective OR 16a-16d to record their entry into the OR and exit upon completion of their assigned work. The entry of the current status for the respective surgical suite is communicated to the server 11, which updates the current status of the management system 10, thereby the server is aware of the statuses of each OR 16a-16d.

In one embodiment, the operation of the management system 10 may include the following steps.

1. Cases are posted by the OR charge nurse via the web interface (access terminal 12n at nursing station) with following details: OR room, scheduled start time, adjusted start time, case type, case complexity, admission type, patient initials, procedure description, surgeon name(s), anesthesia provider name(s), OR nurse name(s), scrub tech name(s), and notes.
2. Posted cases are accessible and editable via the web administration site

### 3. The Day of Surgery

a. Large screen OR display 13 will display cases the day of surgery: posted cases, activity progress for cases yet to be performed and those in progress, completed cases are removed from the OR schedule display (but are still accessible via the web Admin interface, on the access terminal 12n)

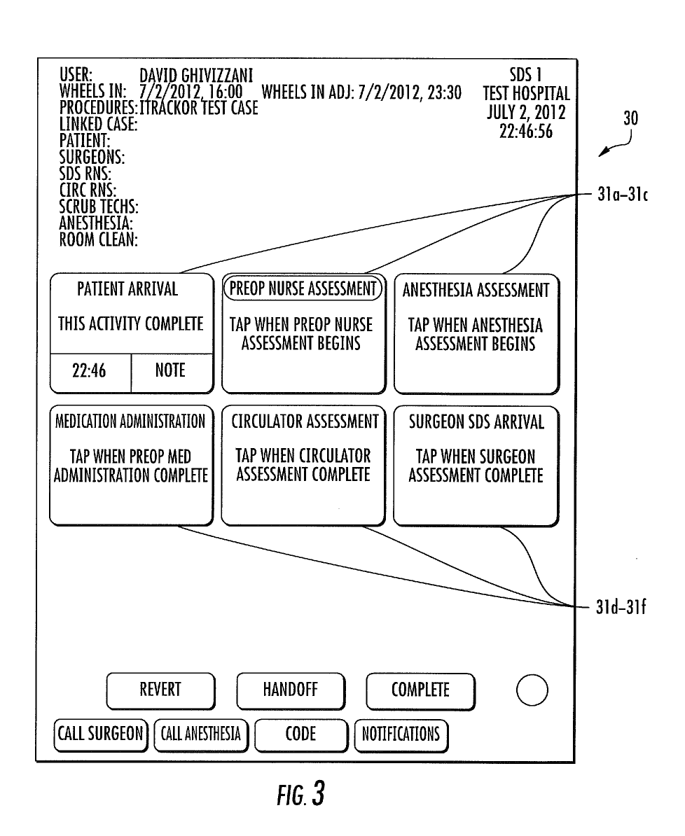

Referring now to FIG. 3, a screenshot 30 from an embodiment of an access terminal 12a-12d in each OR 16a-16d is shown. As mentioned above, each access terminal 12a-12d may be located in the OR, i.e. a Same Day Surgery (SDS) perioperative preparation area. At the OR, the charge RN inputs SDS specific data in the SDS room where patient is prepared for surgery. The access terminals 12a-12n are used to input case-specific activity progress that occurs prior to the procedure. Each access terminal 12a-12n is room specific (i.e. SDS patient bay 8 has an access terminal 12a-12n specific to “SDS 8”) and displays activity buttons 31a-31f that change color depending on the status of that specific activity of the patient/case assigned to that SDS room. Once a procedure is completed, the responsible hospital personnel touch the appropriate button 31a-31f at the access terminal 12a-12d to indicate that the procedure was completed. The server 11 by default will associate the inputs on the access terminal 12a-12d to be associated with the schedule procedure in the respective OR 16a-16d. Once completed, the color of the button 31a-31f changes color, providing an indicator of status in the respective OR 16a-16d.

The access terminals 12a-12d use color coding to provide easy access to information: GREY is an inactive state—no activity is occurring, nor is it time for the activity to begin; YELLOW means it is time for that activity to begin, but the activity has not yet begun; RED means the time has passed for that activity to have been completed, and the activity was never begun; BLUE means the activity is in progress, and that a single tap has occurred on this button; and GREEN means the activity has been completed, and means the button has been tapped once if it is a single tap button, or that the button has been tapped twice if it is a double tap button.

The server 11 may store the parameters that determine YELLOW and RED color changes for the access terminals 12a-12d (these colors occur relative to preset targets), and the parameters are preset via web administration site as part of global setup preferences, but can be altered periodically depending on the timeliness of a particular facility and the progress that facility makes toward becoming more efficient.

4. Preset Parameters related to GREEN (activity completed) color determine, upon completion of an activity, whether a popup window appears and what selection choices that popup will allow to explain any deviation from the target completion time. Popup windows can appear automatically or manually. Selection of a popup choice can be mandatory or voluntary.
5. After a button has turned GREEN and any popup window requirements are satisfied, then the time of activity completion shows in the bottom left corner of the button and the text “Note” appears in the bottom right hand corner if there was delayed relative to its preset completion target. The time area in the bottom right corner becomes activated once a completion time appears.
6. All target times for beginning and completing an activity in the SDS area are based upon the effective wheels in time (either the scheduled wheels in or the adjusted wheels in, if the time has been adjusted). However, there are a couple unique color change rules for this area: medication administration will not turn YELLOW unless the anesthesia evaluation is complete, and no activity block will turn RED except the patient arrival block if the patient has not arrived in SDS. The SDS screen illustratively includes six (6) activity buttons 31a-31f that are used to input progress of perioperative activities associated with that patient/case.
1. these buttons change character according to the status of each activity to provide feedback to the provider in the SDS room
2. the color change of the buttons on the OR access terminal 12a-12d (e.g. iPad tablet computing device, as available from the Apple Corporation of Cupertino, Calif.) SDS screen match the color changes on the large screen OR display
   a. upon tapping buttons on an OR access terminal 12a-12d, data is sent to the server 11, which then compares and computes against previously set parameters. Data is then sent to large screen display 13 as a web page and also sent back to the inputting OR access terminal 12a-12d, so that both the web OR schedule display and the OR access terminals 12a-12d always remain synchronized
3. Each button has four areas:
   a. Title
      i. This is a constant for each button
   b. Instruction
      i. Tells the provider when to tap the button
      ii. Changes depending upon the state of the button
   c. Time area
      i. Displays the time the activity was completed
      ii. Is blank prior to completion of that button's activity
      iii. Once the time appears, this area is active, and tapping on it will bring up the time edit scroll wheel function
   d. Delay area
      i. shows the text “Note” when an activity is completed after the preset completion target time
      ii. is blank prior to the completion of the activity or if the activity was completed on time
      iii. once “Note” appears, this area is active and can be tapped to bring up the popup that lists choices for delay explanations
      iv. Button titles and instructions
         1. Patient Arrival 31a
            a. This button pertains to the arrival of the patient to the SDS area
            b. This button has only four (4) states because the activity is a single instance without duration and therefore does not warrant a BLUE “in progress” state
            c. Instruction when GREY: Tap when patient arrives in Preop
            d. Instruction when YELLOW: Tap when patient arrives in Preop
            e. Instruction when RED: Tap when patient arrives in Preop
            f. Instruction when Green: This activity complete
         2. Preop Nurse Assessment 31b
            a. This button pertains to the perioperative preparation of the patient prior to the patient entering the OR for surgery
            b. This button has five (5) states
            c. Instruction when GREY: Tap when Preop nurse assessment begins
            d. Instruction when YELLOW: Tap when Preop nurse assessment begins
            e. Instruction when RED: Tap when Preop nurse assessment begins
            f. Instruction when BLUE: Tap when Preop nurse assessment complete
            g. Instruction when GREEN: This activity complete
         3. Anesthesia Assessment 31c
            a. This button pertains to the perioperative assessment of the patient by the anesthesia team prior to the patient entering the OR for surgery
            b. This button has five (5) states
            c. Instruction when GREY: Tap when anesthesia assessment begins
            d. Instruction when YELLOW: Tap when anesthesia assessment begins
            e. Instruction when RED: Tap when anesthesia assessment begins
            f. Instruction when BLUE: Tap when anesthesia assessment complete
            g. Instruction when GREEN: This activity complete
         4. Medication Administration 31c
            a. This button pertains to the administration of perioperative medications (sedatives and other meds) to the patient prior to the patient entering the OR for surgery
            b. This button has only four (4) states because the activity is of short duration, there is no BLUE state
            c. Instruction when GREY: Tap when Preop medication complete
            d. Instruction when YELLOW: Tap when Preop medication complete
            e. Instruction when RED: Tap when Preop medication complete
            f. Instruction when GREEN: This activity complete
         5. Circulator Assessment 31e
            a. This button pertains to the perioperative assessment of the patient by the OR circulating RN prior to the patient entering the OR for surgery
            b. This button has only four (4) states; because the activity is of short duration, there is no BLUE state
            c. Instruction when GREY: Tap when circulator assessment complete
            d. Instruction when YELLOW: Tap when circulator assessment complete
            e. Instruction when RED: Tap when circulator assessment complete
            f. Instruction when GREEN: This activity complete
         6. Surgeon SDS Arrival 31f
            a. This button pertains to the arrival of the surgeon in SDS prior to the patient entering the OR
            b. This button has only four (4) states because the activity is a single instance without duration and therefore does not warrant a BLUE “in progress” state
            c. Instruction when GREY: Tap when surgeon arrives in SDS
            d. Instruction when YELLOW: Tap when surgeon arrives in SDS
            e. Instruction when RED: Tap when surgeon arrives in SDS
            f. Instruction when Green: This activity complete
   e. Operating rooms
      i. Charge RN inputs OR specific data (if not previously inputted at time the case was first posted)
         1. OR room where cases will be performed (usually done in advance, but room changes on the actual day of surgery are common)
         2. Personnel providing care in each OR and for each case
      ii. OR access terminals 12a-12d are used to input case-specific activity progress that occurs before, during, and after the procedure, but is directly related to the operating room where the procedure occurs
         1. OR access terminal 12a-12d are room specific (i.e., OR#8 has an OR access terminal 12a-12d specific to “OR 8”) and display activity buttons that change color depending on the status of that specific activity of the patient/case assigned to that SDS room and whether or not the buttons have been tapped
         2. Color change scheme is same as SDS regarding meaning of GREY, YELLOW, RED, BLUE, GREEN colors
         3. Active areas of the buttons and general behavior of buttons are similar to buttons in SDS screen
         4. Unlike the SDS, target times for beginning and completing an activity in the OR have varying schemes.
            a. OR Ready for Patient targets and color changes are relative to the effective wheels in time
            b. Wheels in targets and color changes are relative to the effective wheels in time
            c. Induction completion target is relative to the actual wheels in time (wheels in completion triggers YELLOW color for induction and starts timer for completion target)
            d. Surgeon arrival in OR target is relative to the actual wheels in time (Wheels in completion triggers YELLOW color for surgeon arrival in OR and starts timer for completion target)
            e. Prep & Drape completion target is relative to the actual induction completion time (induction completion triggers YELLOW color for Prep & Drape and starts timer for completion target)
            f. Incision/procedure begin target is relative to the actual Prep & Drape completion time (Prep & Drape completion triggers YELLOW color for Incision/Procedure and starts timer for activity begin target). There is no incision/procedure completion target.
            g. There is no specific closure begin or completion target. Incision/procedure begin triggers YELLOW color change for Closure/Procedure End, but there is no RED color change for this button

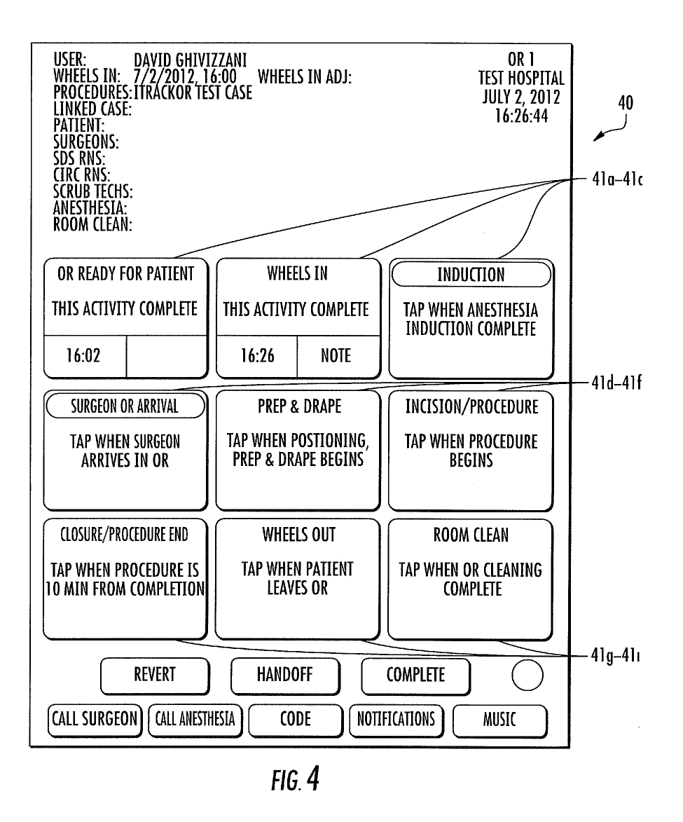

Referring now to FIG. 4-6, screenshots 40, 50, 60 from the OR access terminals 12a-12d during different steps of the OR procedure. The OR screen has nine (9) activity buttons 41a-41i that are used to input progress of perioperative activities associated with that patient/case. These buttons 41a-41i change character according to the status of each activity to provide feedback to the provider in the OR. The color change of the buttons on the access terminal 12a-12d OR screen match the color changes on the large screen OR display 13. Upon touching buttons on the access terminal 12a-12d, data is sent to the server 11, which then compares and computes against previously set parameters. Data is then sent to large screen display 13 as a web page and also sent back to the inputting OR access terminal 12a-12d, so that both the web OR schedule display and the OR access terminals 12a-12d always remain in sync.

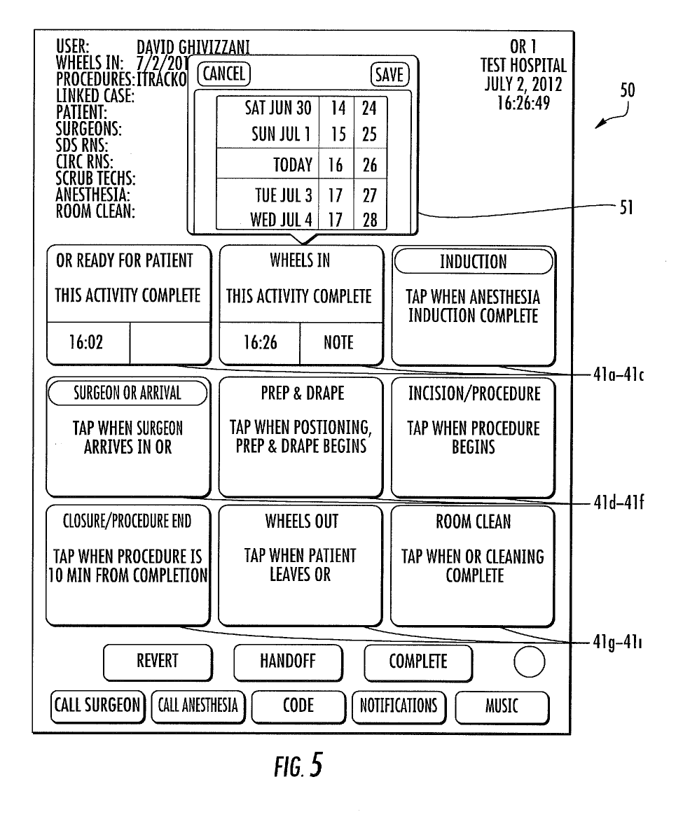

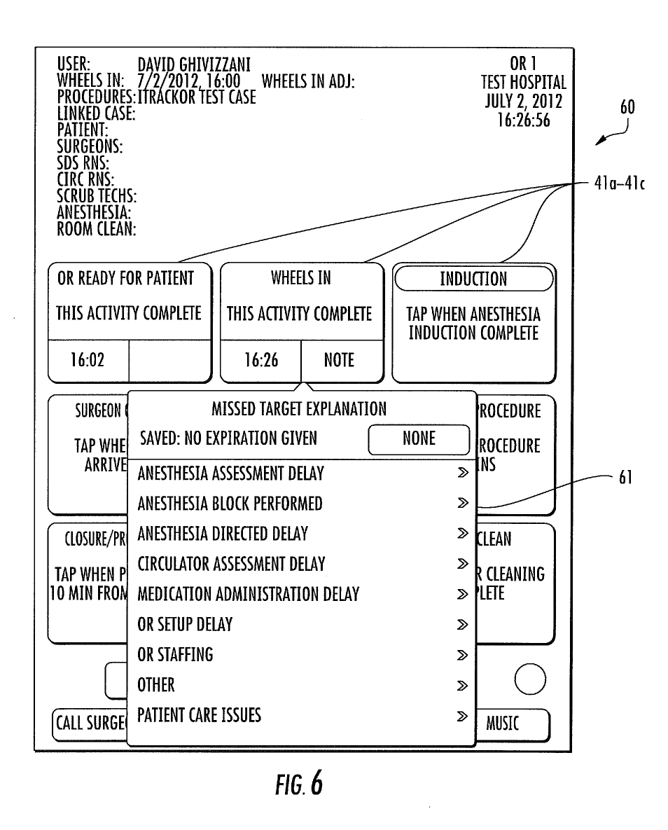

Each button 41a-41i has four areas:
1. Title
   a. This is a constant for each button
2. Instruction
   a. Tells the provider when to tap the button
   b. Changes depending upon the state of the button
3. Time area
   a. Displays the time the Activity was completed
   b. Is blank prior to completion of that button's activity
   c. Once the time appears, this area is active, and tapping on it will bring up the time edit scroll wheel function 51 (FIG. 5)
   d. Delay area
      i. shows the text “Note” when an activity is completed after the preset completion target time
      ii. is blank prior to the completion of the activity or if the activity was completed on time
      iii. Tapping on the delay area brings up popup box 61 with a delay reason selection list (FIG. 6)
         Button titles and instructions
1. OR Ready for Patient 41a
   a. This button pertains to preparing the OR for a particular procedure
      i. Setting up equipment
      ii. Opening, counting, laying out sterile supplies expected to be used
      iii. Retrieving expected medications to be used on the surgical field
   b. Instruction when GREY: Tap when OR setup begins
   c. Instruction when YELLOW: Tap when OR setup begins
   d. Instruction when RED: Tap when OR setup begins
   e. Instruction when BLUE: Tap when OR setup complete
   f. Instruction when Green: This activity complete
2. Wheels In 41b
   a. This button pertains to the entry of the patient into the OR
   b. This button has only four (4) states because the activity is a single instance without duration and therefore does not warrant a BLUE “in progress” state
   c. Instruction when GREY: Tap when patient enters OR
   d. Instruction when YELLOW: Tap when patient enters OR
   e. Instruction when RED: Tap when patient enters OR
   f. Instruction when Green: This activity complete
3. Induction 41c
   a. This button pertains to the induction of anesthesia
   b. This button has only four (4) states because the short duration of the activity does not warrant a BLUE “in progress” state
   c. Instruction when GREY: Tap when anesthesia induction complete
   d. Instruction when YELLOW: Tap when anesthesia induction complete
   e. Instruction when RED: Tap when anesthesia induction complete
   f. Instruction when Green: This activity complete
4. Surgeon OR Arrival 41d
   a. This button pertains to the arrival of the surgeon into the OR after the patient has entered the OR
   b. This button has only four (4) states because the activity is a single instance without duration and therefore does not warrant a BLUE “in progress” state
   c. Instruction when GREY: Tap when surgeon arrives in OR
   d. Instruction when YELLOW: Tap when surgeon arrives in OR
   e. Instruction when RED: Tap when surgeon arrives in OR
   f. Instruction when Green: This activity complete
5. Prep & Drape 41e
   a. This button pertains to the positioning, prepping, and draping that occurs after anesthesia has been induced
   b. This button has only four (4) states because the because the short duration of the activity does not warrant a BLUE “in progress” state
   c. Instruction when GREY: Tap when Positioning, Prep & Drape Begins
   d. Instruction when YELLOW: Tap when positioning, Prep & Drape begins
   e. Instruction when RED: Tap when Positioning, Prep & Drape begins
   f. Instruction when Green: This activity complete
6. Incision/Procedure 41f
   a. This button pertains to the start of the actual procedure, whether the start is with an incision, manipulation, injection or other type of start
   b. This button has five (5) states, but is only tapped once because it is linked with the closure button (see below), which completes both the closure activity and the incision/procedure activity
   c. Instruction when GREY: Tap when procedure begins
   d. Instruction when YELLOW: Tap when procedure begins
   e. Instruction when RED: Tap when procedure begins
   f. Instruction when BLUE: This activity in progress
   g. Instruction when Green: This activity complete
7. Closure/procedure end 41g
   a. This button is tapped to turn BLUE and signal that there is 10 minutes or less remaining in the procedure
   b. When this button is tapped again to turn it GREEN, it also turns the incision/procedure button GREEN, because “closure” is just the final part of the procedure itself, so both activities necessarily end at the same time (to eliminate needless tapping, the incision/procedure button can only be completed by completing the closure button)
   c. This button has four (4) states, because there is no RED completion target for either closure to begin or the procedure to end
   d. Instruction when GREY: Tap when procedure is 10 min from completion
   e. Instruction when YELLOW: Tap when procedure is 10 min from Completion
   f. Instruction when BLUE: Tap when procedure is complete
   g. Instruction when Green: This activity complete
8. Wheels Out 41h
   a. This button pertains to the exit of the patient out of the OR
   b. This button has only four (4) states because the activity is a single instance without duration and therefore does not warrant a BLUE “in progress” state
   c. Instruction when GREY: Tap when patient leaves OR
   d. Instruction when YELLOW: Tap when patient leaves OR
   e. Instruction when RED: Tap when patient leaves OR
   f. Instruction when Green: This activity complete
9. Room Clean 41i
   a. This button pertains to cleaning the OR after the patient has been transported to the recovery room
   b. This button has only four (4) states because the because the short duration of the activity does not warrant a BLUE “in progress” state
   c. Instruction when GREY: Tap when room cleaning complete
   d. Instruction when YELLOW: Tap when room cleaning complete
   e. Instruction when RED: Tap when room cleaning complete
   f. Instruction when Green: This activity complete

In the illustrated embodiments, each OR access terminal 12a-12d comprises a touch input device. In other embodiments, other computing devices and input methods could be used (e.g. voice recognition, physical buttons, etc.). Also, the access terminals 12a-12n can be installed in other areas of the hospital, such as recovery rooms and other preparation rooms, and regular hospital rooms.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An operating room management system for monitoring a plurality of operating rooms, the operating room management system comprising:
a server;
a plurality of access devices, each access device being associated with a respective operating room from the plurality thereof and for
communicating with said server,
receiving input regarding a current status for a procedure associated with the respective operating room, and
displaying a local status interface including at least one performance characteristic for the procedure associated with the respective operating room; and
a display communicating with said server and displaying a global status interface comprising the current status and the at least one performance characteristic of the plurality of the operating rooms.

2. The operating room management system of claim 1 wherein the local status interface includes a plurality of buttons associated with respective activities for the procedure associated with the respective operating room.

3. The operating room management system of claim 1 wherein the at least one performance characteristic comprises a colorized indicator for timely performance for the procedure associated with the respective operating room.

4. The operating room management system of claim 1 wherein the global status interface includes a progress bar indicating a current progress of the procedure associated with the respective operating room.

5. The operating room management system of claim 1 wherein the global status interface includes a plurality of characteristics associated with the plurality of operating rooms including a scheduled procedure start time, a procedure description, assigned personnel, and associated notes.

6. The operating room management system of claim 1 wherein said server selectively changes the at least one performance characteristic based upon historical data, and assigned personnel for the procedure associated with the respective operating room.

7. The operating room management system of claim 1 further comprising at least one mobile access terminal communicating with said server and associated with a respective user assigned to a given procedure for a given operating room.

8. The operating room management system of claim 7 wherein said server sends a text message to the at least one mobile access terminal based upon a current progress of the given procedure.

9. The operating room management system of claim 1 wherein each access terminal includes a touch screen interface.

10. An operating room management system for monitoring a plurality of operating rooms, the operating room management system comprising:
a server;
a plurality of access devices, each access device being associated with a respective operating room from the plurality thereof and for
communicating with said server,
receiving input regarding a current status for a procedure associated with the respective operating room, and
displaying a local status interface including at least one performance characteristic for the procedure associated with the respective operating room, and a plurality of buttons associated with respective activities for the procedure associated with the respective operating room; and
a display communicating with said server and displaying a global status interface comprising the current status for each operating room, the at least one performance characteristic for each operating room, and a progress bar for each operating room indicating a current progress of the procedure associated with the respective operating room.

11. The operating room management system of claim 10 wherein the at least one performance characteristic comprises a colorized indicator for timely performance for the procedure associated with the respective operating room.

12. The operating room management system of claim 10 wherein the global status interface includes a plurality of characteristics associated with the plurality of operating rooms including a scheduled procedure start time, a procedure description, assigned personnel, and associated notes.

13. The operating room management system of claim 10 wherein said server selectively changes the at least one performance characteristic based upon historical data, and assigned personnel for the procedure associated with the respective operating room.

14. The operating room management system of claim 10 further comprising at least one mobile access terminal communicating with said server and associated with a respective user assigned to a given procedure for a given operating room.

15. The operating room management system of claim 14 wherein said server sends a text message to the at least one mobile access terminal based upon a current progress of the given procedure.

16. A method of using an operating room management system for monitoring a plurality of operating rooms, the operating room management system comprising a server, a plurality of access devices, each access device being associated with a respective operating room from the plurality thereof, and a display, the method comprising:
using each access terminal for
communicating with the server,
receiving input regarding a current status for a procedure associated with the respective operating room, and
displaying a local status interface including at least one performance characteristic for the procedure associated with the respective operating room; and
using the display for communicating with the server and displaying a global status interface comprising the current status and the at least one performance characteristic of the plurality of the operating rooms.

17. The method of claim 16 wherein the local status interface includes a plurality of buttons associated with respective activities for the procedure associated with the respective operating room.

18. The method of claim 16 wherein the at least one performance characteristic comprises a colorized indicator for timely performance for the procedure associated with the respective operating room.

19. The method of claim 16 wherein the global status interface includes a progress bar indicating a current progress of the procedure associated with the respective operating room.

20. The method of claim 16 wherein the global status interface includes a plurality of characteristics associated with the plurality of operating rooms including a scheduled procedure start time, a procedure description, assigned personnel, and associated notes.
